(19) United States
(12) Patent Application Publication
(10) Pub. No.: US 2025/0263611 A1
(43) Pub. Date: Aug. 21, 2025

(54) HEAT INTEGRATION/RECOVERY AT SYNGAS COOLER OUTLET

(71) Applicant: MOTE, INC., Los Angeles, CA (US)

(72) Inventors: Joshuah STOLAROFF, Los Angeles, CA (US); Alison CHEN, Spring, TX (US)

(73) Assignee: MOTE, INC., Los Angeles, CA (US)

(21) Appl. No.: 18/856,967

(22) PCT Filed: Apr. 14, 2023
(86) PCT No.: PCT/US2023/018605

§ 371 Date: Oct. 15, 2024

Related U.S. Application Data
(60) Provisional application No. 63/331,621, filed on Apr. 15, 2022.

(51) Int. Cl. C10J 3/86; C01B 3/02

(52) U.S. Cl. CPC C10J 3/86; C01B 3/02; C10J 2300/1687; C10J 2300/1884; C10J 2300/1892

(57) ABSTRACT

A system and method for the generation of syngas from the gasification of biomass is disclosed herein. The system makes use of heat generated during gasification and subsequent steps, and recycles this heat to other process streams within the system.

### CROSS REFERENCE TO RELATED APPLICATIONS

This application claims the benefit of priority to U.S. Provisional Patent Application Ser. No. 63/331,621, filed Apr. 15, 2022, which is incorporated by reference herein in its entirety.

### BACKGROUND AND FIELD

### I. Field

This disclosure and the associated invention(s) relate at least to the field of renewable fuels production, and in particular, systems and methods for carrying out biomass gasification.

### II. Background

Due to fast climate change and foreseen damage through global warming, access to clean and green energy has become essential for the sustainable development of a global society. Biomass is one of the important renewable energy resources, as it is rich in energy and oftentimes considered an unwanted waste product.

Among the various routes available for biomass-based energy generation, biomass gasification is one of the most important routes that is being studied extensively. Due to the increasing interest in biomass gasification, several energy producers have developed and attempted to optimize biomass gasification systems. One of the major problems associated with biomass gasification is efficiency. Although large quantities of energy are generated during biomass gasification, each process unit within a biomass gasification plant represents a potential point of heat loss. The present invention(s) seek to overcome these issues and others as will be explained in detail below.

### SUMMARY

This present invention(s) provide at least methods of increasing the efficiency of a biomass gasification system by recycling heat generated within the system. By recycling heat that would otherwise be lost to the atmosphere, the inventors have developed a method to increase the overall efficiency of biomass gasification systems. For a gasification plant capacity of 350 short tons of biomass per day on an as-fed basis, approximately 12 GJ/h of heat can be utilized. This degree of heat utilization represents a major contributor to plant efficiency.

In some aspects, a method for recycling heat from a biomass gasification process is disclosed. The process comprises receiving a biomass feed at a biomass feed inlet of a syngas generation system, gasifying, using a gasifier of the syngas generation system, the biomass feed to produce hot syngas, cooling the hot syngas in a first process unit to produce a first cooled syngas stream, and cooling the first cooled syngas stream in a second process unit to produce a second cooled syngas stream. In some aspects, heat absorbed in the second process unit is utilized by integrating with another process stream.

Some aspects of the disclosure are directed to a syngas generation system comprising a gasifier for producing hot syngas from biomass, a first process unit configured to cool the hot syngas to produce a first cooled syngas stream, a second process unit configured to cool the first cooled syngas stream to produce a second cooled syngas stream. In some aspects, heat absorbed in the second process unit is utilized by integrating with another process stream within the syngas generation system.

In some aspects, the hot syngas is at a temperature ranging from about 750° C. to about 950° C. In some aspects, the first process unit is a syngas cooler. In some aspects, the first cooled syngas stream is at a temperature ranging from about 500° C. to about 570° C. In some aspects, the second cooled syngas stream is at a temperature ranging from about 250° C. to about 350° C. In some aspects, heat absorbed in the second process unit is used to generate steam.

Synthesis gas, or syngas, is the term for raw gas produced from gasification of a biomass feedstock. Syngas consists of hydrogen (H₂) and carbon monoxide (CO) as primary components, and carbon dioxide (CO₂) and methane (CH₄) as secondary components.

As used herein, various terminology is used for the purpose of describing particular implementations only and is not intended to be limiting of implementations. For example, as used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed configuration, the term “substantially” may be substituted with “within [a percentage] of” what is specified, where the percentage includes 0.1, 1, 5, and 10 percent.

Throughout this application, the term “about” is used to indicate that a value includes the inherent variation of error for the measurement or quantitation method. In various embodiments, as used herein, the term “about” refers to include the usual error range for the respective value readily known. Reference to “about” a value or parameter herein includes (and describes) embodiments that are directed to that value or parameter per se. For example, description referring to “about X” includes description of “X”. In some embodiments, “about” may refer to ±15%, ±10%, ±5%, or ±1% as understood by a person of skill in the art.

The use of the word “a” or “an” when used in conjunction with the term “comprising” may mean “one,” but it is also consistent with the meaning of “one or more,” “at least one,” and “one or more than one.”

The phrase “and/or” means “and” or “or”. To illustrate, A, B, and/or C includes: A alone, B alone, C alone, a combination of A and B, a combination of A and C, a combination of B and C, or a combination of A, B, and C. In other words, “and/or” operates as an inclusive or. Similarly, the phrase “A, B, C, or a combination thereof” or “A, B, C, or any combination thereof” includes: A alone, B alone, C alone, a combination of A and B, a combination of A and C, a combination of B and C, or a combination of A, B, and C.

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The compositions and methods for their use can “comprise,” “consist essentially of,” or “consist of” any of the ingredients or steps disclosed throughout the specification. Compositions and methods “consisting essentially of” any of the ingredients or steps disclosed limits the scope of the claim to the specified materials or steps which do not materially affect the basic and novel characteristic of the claimed invention(s). Any implementation of any of the systems, methods, apparatus, and article of manufacture can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb. Apparatus, systems, and methods “consisting essentially of” any of the components, apparatus, or steps disclosed limits the scope of the claim to the specified materials or steps which do not materially affect the basic and novel characteristic of the claimed implementation. Additionally, the term “wherein” may be used interchangeably with “where”.

It is contemplated that any embodiment discussed in this specification can be implemented with respect to any method or composition of the invention, and vice versa. Furthermore, compositions of the invention can be used to achieve methods of the invention.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention(s). Invention(s) may be better understood by reference to one or more of these drawings in combination with the detailed description of specific embodiments presented herein.

FIG. 1 is a schematic representations of a syngas generation process in accordance with various aspects of the present disclosure.

FIG. 2 is a schematic representation of a syngas cooling unit, in accordance with various aspects of the present disclosure.

### DETAILED DESCRIPTION

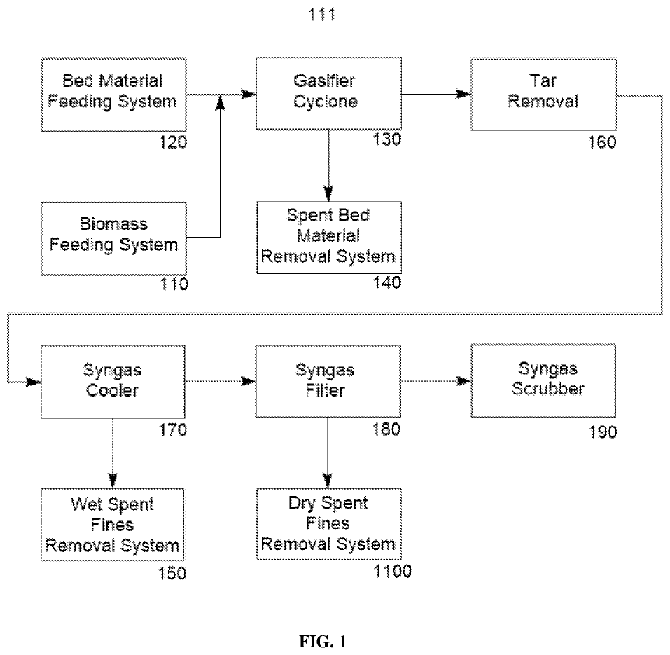

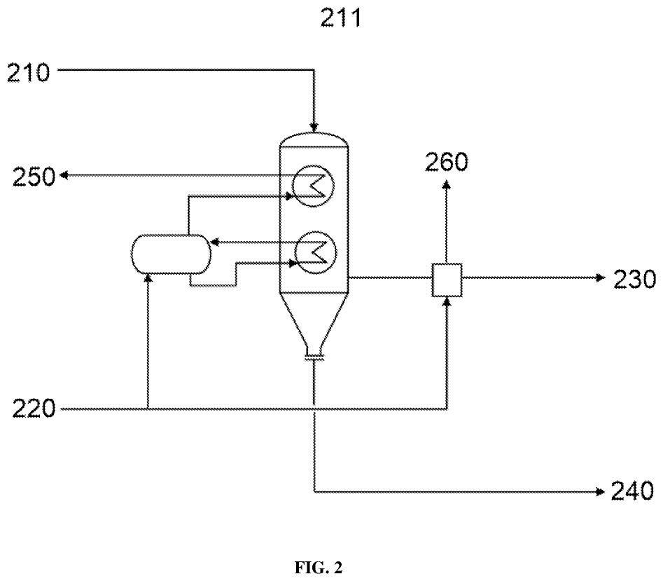

With reference to FIGS. 1 and 2, shown is a synthetic gas (syngas) generation process by a syngas generation system for gasifying biomass to ultimately produce and recover synthetic gas (syngas).

The syngas generation process begins with preparation of a biomass feed to be utilized to produce syngas. The biomass may include one or more of forest biomass such as branches, brushes, etc., from forest management, sawmill residue or shrub and chaparral, agricultural residues such as but not limited to almond shells, orchard trimmings, low moisture agricultural residue, urban waste such as but not limited to dry municipal solid waste, construction wood, seaweed, algae, greenwaste, etc., or may originate from crops such as sawgrass specifically grown to be utilized as biomass.

FIG. 1 shows a schematic representation of a syngas generation process in accordance with various embodiments of the present disclosure. In various aspects, the syngas generation process 111 includes a biomass feeding system 110 for feeding biomass into a gasifier cyclone 130 for gasification of the biomass feed to generate the syngas. In some aspects, the biomass feed is transported to the gasifier cyclone 130 via flight chain conveyor. The biomass feeding system 110 can include a biomass distribution screw conveyor located at the top of the biomass feeding system 110 for delivering the biomass to the gasifier cyclone 130. In some aspects, biomass is dropped from the biomass distribution screw conveyor into the biomass storage silo, which is purged with nitrogen to avoid dust explosion or self-ignition of the dried fuel. From the storage silo, the fuel is moved through the biomass storage silo discharger and biomass distribution screw into one or more (e.g., two) lock hoppers, where the biomass feedstock pressure is alternately increased from atmospheric pressure to system pressure with carbon dioxide. It is then discharged to the biomass surge hopper as described below and depressurized to begin the fill step. From the pressurized lock hoppers, the biomass is fed to biomass surge hopper with live bottom screws via lock hopper discharger. The biomass is fed from the surge hoppers through the metering screw conveyor to the biomass feeding screw conveyor that feeds the biomass into the gasifier 30.

The syngas generation process 111 also includes a bed material feeding system 20 for feeding bed material to gasifier cyclone 130. In some aspects, the bed material comprises dolomite, kaolin, olivine, muscovite, sand, limestone, or a combination thereof. In some aspects, the bed material feeding system is a single bed material feeding lock-hopper system. In some aspects, the lock-hopper system includes a lock/surge hopper for pressurizing bed material to system pressure with nitrogen. In some aspects, the bed material feeding system comprises a diverting screw conveyor for feeding bed material to the gasifier.

In various aspects, the syngas generation system 111 includes a gasifier 130 that is designed for or configured to gasify a biomass feed received from biomass feeding system 110. In various aspects, the gasifier 130 includes a natural gas-fueled start-up heater that is used to heat the reactor of the gasifier during startup of the gasifier reactor. In some aspects, the gasifier reactor may be designed to handle biomass at a rate ranging from about 10,000 to about 15,000 kg/h biomass. In some aspects, the gasifier reactor may be designed to handle biomass having a moisture content of from about 15% to about 20%, at this rate.

In some aspects, the biomass feed is gasified by the gasifier 130 in the presence of oxygen and superheated steam. In some aspects, the gasifier 130 is a pressurized bubbling fluidized bed refractory lined pressure vessel. In some aspects, the oxygen and steam are introduced through a valve system to multiple locations in the gasifier 130. In some aspects, oxygen is preheated to a temperature of about 150° C. to about 200° C., and preferably preheated to about 175° C. in an oxygen preheater. The biomass is devolatilized in the gasifier 130 while at least a portion of char is gasified and at least a portion of char is combusted to maintain the desired gasification temperature. In some aspects, the produced syngas exits the gasifier 130 at the top of the reactor. In some aspects, entrained dust is at least partially removed from the hot gas in the cyclone and returned to the reactor's fluidized bed via the cyclone return pipe (e.g., dipleg).

After syngas is generated in gasifier cyclone 130, the syngas is fed to tar removal system 160 for removal of tar from the syngas. The syngas may still include molten solids, remnant particulate matter, and char. In some aspects, tar removal system 160 includes a hot oxygen burner (HOB) that converts tar components and other hydrocarbon compounds into hydrogen and carbon monoxide. In some aspects, tar removal system 160 utilizes recycled syngas that has been compressed downstream of the gasifier cyclone 130 for fuel. In some aspects, from about 4% to about 14% of the syngas may be recycled or provided to the tar removal system 160 to serve as fuel for operating the tar removal system 160. Both syngas and molten solids flow downward through the tar removal vessel to the syngas cooler 170.

In some aspects, the syngas generation process 111 includes a syngas cooler 170. In some aspects, syngas cooler cools syngas to a temperature ranging from about 500° C. to about 570° C., preferably to a temperature ranging from about 530° C. to about 550° C. In some aspects, syngas cooler cools syngas to a temperature of about 540° C. In some aspects, the syngas cooler includes a boiler, a superheater, and a steam drum. In some aspects, boiler feed water is sent to the steam drum of the syngas cooler 170 where it is preheated by a low pressure steam coil. In some aspects, spent fines disengage from the gas stream and drop by gravity into a water bath. In some aspects, the cooled wet spent fines are then sent to the wet spent fines removal system 150 of syngas generation system 111. In some aspects, heat recovered from the syngas cooler is used to heat boiler feed water to produce superheated steam. In some aspects, heat recovered from the syngas cooler is used to generate superheated steam. In some aspects, the superheated steam is generated at a temperature ranging from about 270° C. to about 310° C. In some aspects, the superheated steam is generated at a temperature ranging of about 288° C. In some aspects, the superheated steam is generated at a pressure ranging from about 30 barg to about 50 barg. In some aspects, the superheated steam is generated at a pressure of about 41 barg. In some aspects, the superheated steam is utilized by integrating with another process stream syngas generation process 111. In some aspects, syngas leaving syngas cooler 170 is further cooled by boiler feed water (BFW) spray to approximately 300° C. before it is sent to syngas filter 180.

In some aspects, heat is recovered from syngas exiting the syngas cooler by a heat exchanger 260 (FIG. 2). In some aspects, heat recovered by the heat recovery unit is used to produce a secondary steam stream 270 (FIG. 2). In some aspects, heat recovered by heat exchanger 260 is utilized by integrating with another process stream syngas generation process 111. In some aspects, heat recovery using heat exchanger 260 is performed as an alternative to cooling by BFW spray. In some aspects, heat recovered from the syngas cooler is used to generate superheated steam.

In some aspects, syngas cooled by the syngas cooler is then sent to syngas filter 180. In some aspects, syngas leaving the syngas cooler is at a temperature ranging from about 250° C. to about 350° C. In some aspects, syngas leaving the syngas cooler is at a temperature of about 300° C. In some aspects, syngas cooled by the quench water stream is then sent to syngas filter 180. In some aspects, syngas cooled by the quench water stream is at a temperature ranging from about 250° C. to about 350° C. In some aspects, syngas cooled by the quench water stream is at a temperature of about 300° C.

In some aspects, the syngas filter 180 is configured to receive syngas and spent fines from the syngas cooler 170. In some aspects, the syngas filter is a candle filter unit including metal candle filter elements arranged in clusters and installed into a tube sheet. In some aspects, the filter candles are cleaned with carbon dioxide by back pulsing from the blowback tank. In some aspects, the filter unit is operated at system pressure and the pulsing gas is injected at an elevated temperature.

In some aspects, syngas generation system 111 includes a syngas scrubber 190 that is configured to receive the syngas from the syngas filter 180 and further cool the syngas to a temperature ranging from about 30° C. to about 60° C. In some aspects, syngas scrubber 190 cools the syngas to a temperature of about 45° C. In some aspects, syngas scrubber 190 removes part of the water vapor and remaining contaminants from the syngas and protects the syngas compression system and the downstream chemical processes from solids contamination in the event of hot oxygen burner or syngas filter 180 malfunction. In some aspects, syngas scrubber 190 has an inlet quench system where water is pumped by cooling pumps through nozzles into the syngas feed stream just before entry to the scrubber. In some aspects, the gas is then cooled further through a first stage bed. In some aspects, scrubber water is circulated by circulation pumps through a heat recovery heat exchanger to the top of the first stage bed. In the second stage, the gas is cooled through the second stage bed by recirculated water. In some aspects, a process condensate stream is injected at the top of the syngas scrubber 190 to allow for additional chloride removal. In some aspects, chemicals are added to the scrubber water to adjust the pH value of the water, enhance chloride removal, and/or neutralize ammonia from the syngas.

In some aspects, the syngas generation system 111 includes a solid removal system that includes spent bed material removal system 140 and dry spent fines removal system 1100. In some aspects the spent bed material removal system 140 is configured to remove spend bed material from the gasifier 130. In some aspects, dry spent fines removal system 1100 is configured to remove dry spent fines from syngas filter 180. In some aspects, the solid removal system is configured to store removed solids. For example, the solid removal systems 140 and 1100 can include two separate solid removal systems including lock-hoppers, conveyor hoppers and storage silos designed to handle the solid material from the gasifier 130 and syngas filter 180. In some aspects, spent bed material is removed through the bottom of the gasifier 130 using a water-cooled screw to a nitrogen-pressurized lock hopper. In some aspects, spent bed material is conveyed pneumatically through a gasifier spent bed material conveyor hopper to the common gasifier spent bed material silo by using nitrogen or any other inert gas available. In some aspects, dry spent fines from the syngas filter are removed using water-cooled screws and are passed through a lock and conveyor hopper. In some aspects, a buffer hopper located after the cooling screw allows continuous operation of the screw. In some aspects, dry spent fines from the syngas filter 180 are loaded into a dry spent fines storage silo using nitrogen or any other dry inert gas available.

In various embodiments, syngas generation system 111 also includes wet spent removal system 150 that is configured to receive wet spent fines that drop in from the syngas cooler water bath. In some aspects, water from this system is recycled back to the water in the syngas cooler by a pump. In some aspects, the accumulated wet spent fines are cooled, depressurized, and removed from the wet spent removal system 150.

In various aspects, nitrogen, carbon dioxide, water, etc., that are used by the syngas generation system 111 to generate syngas can be provided by auxiliary systems that are coupled to the syngas generation system 111. For example, the auxiliary systems can include a nitrogen supply system, a carbon dioxide supply system, a water supply system, etc. The auxiliary systems can also include one or more heat exchange systems. For instance, the nitrogen supply system can supply nitrogen which can be used as an inert gas in the syngas generation system 111 and as a fuel diluent for the hot oxygen burner during start-up. In some aspects, nitrogen can supplied to the project at different pressures, for example, nitrogen can be supplied to one component of syngas generation system at a high pressure, and nitrogen can be supplied to a different component of syngas generation system at a lower pressure. In some aspects, a unique buffer drum is used at each nitrogen pressure to ensure adequate nitrogen is available for safe operation, start-up, and shutdown of the unit. In some aspects, nitrogen from the buffer drums can flow to a low-pressure and a high-pressure nitrogen header that distributes nitrogen to nitrogen consumers.

In some aspects, a carbon-dioxide supply system provides sulfur free-CO₂ to the syngas generation system 111 from an acid gas removal unit. In some aspects, this CO₂ stream is fed to unique high pressure and low pressure buffering drums in the carbon-dioxide supply system. In some aspects, CO₂ is distributed from these drums to the various components within the syngas generation system 111.

In some aspects, a water supply system includes a high-pressure cooling water system and a high-pressure sealing water system. In some aspects, the high-pressure cooling water system is used to cool the gasifier bottom spent bed material, the dry spent fines, and the biomass feeding screws. In some aspects, the cooling water system is a closed-loop system operated at high pressure. In some aspects, the loop includes circulating pumps, a storage drum, and a cooling heat exchanger. In some aspects, the high-pressure sealing water system is used to supply water to the mechanical seals of the solids removal systems and biomass feeding screw shafts. In some aspects, the loop includes circulating pumps, a storage drum, and a cooling heat exchanger.

In some aspects, the heat exchange system of the auxiliary systems is a hot process heat exchange system including a hot process cooling water system that is a closed-loop system and uses a series of pumps, storage drum, and heat exchangers to exchange heat between portions of the facility. In some aspects, the hot process water supply cools the scrubber bottoms stream and the high pressure cooling water loop water, the heated process water is then available as a heat source for biomass feed drying, as needed.

Returning to FIG. 2, in various aspects, syngas cooler 211 includes a syngas feed 210. In some aspects, the syngas feed comprises hot syngas from a tar removal unit (not depicted). The syngas from the tar removal unit may be at a temperature ranging from about 750° C. to about 950° C. Boiler feed water 220 is provided to syngas cooler 211 and to heat exchanger 260. The portion of the boiler feed water 220 that is provided to syngas cooler 211 is heated by the hot syngas within the syngas cooler and is converted to superheated steam 250. The superheated steam 250 is at a temperature ranging from about 270° C. to 310° C., and a pressure ranging from about 30 barg to about 50 barg. After passing through syngas cooler 211, the syngas temperature has been reduced to a temperature ranging from about 500° C. to about 570° C. The cooled syngas then passes to secondary heat exchanger 260 where heat is absorbed from the syngas, and the syngas is further cooled to provide cooled syngas 230 at a temperature ranging from about 250° C. to about 350° C. Spent fines 240 from the syngas are collected as a stream exiting a bottom portion of syngas cooer 211. Heat exchanger 260 can be used to transfer heat to boiler feed water 220 to produce a secondary steam stream 270. Heat from secondary steam stream 270 can be utilized by integrating with another process stream within syngas generation process 111 (FIG. 1).

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

What is claimed is:

1. A method for recycling heat from a biomass gasification process, comprising:
receiving a biomass feed at a biomass feed inlet of a syngas generation system;
gasifying, using a gasifier of the syngas generation system, the biomass feed to produce hot syngas;
cooling the hot syngas in a first process unit to produce a first cooled syngas stream; and
cooling the first cooled syngas stream in a second process unit to produce a second cooled syngas stream;
wherein heat absorbed in the second process unit is utilized by integrating with another process stream.

2. The method of claim 1, wherein the hot syngas is at a temperature ranging from about 750° C. to about 950° C.

3. The method of claim 1, wherein the first process unit is a syngas cooler.

4. The method of claim 1, wherein the first cooled syngas stream is at a temperature ranging from about 500° C. to about 570° C.

5. The method of claim 1, wherein the second process unit is a heat exchanger.

6. The method of claim 1, wherein the second cooled syngas stream is at a temperature ranging from about 250° C. to about 350° C.

7. The method of claim 1, wherein heat absorbed in the second process unit is used to generate steam.

8. A syngas generation system, comprising:
a gasifier for producing hot syngas from biomass;
a first process unit configured to cool the hot syngas to produce a first cooled syngas stream;
a second process unit configured to cool the first cooled syngas stream to produce a second cooled syngas stream;
wherein heat absorbed in the second process unit is utilized by integrating with another process stream within the syngas generation system.

9. The system of claim 8, wherein the hot syngas is produced at a temperature ranging from about 750° C. to about 950° C.

10. The system of claim 8, wherein the first process unit is a syngas cooler.

11. The system of claim 8, wherein the first cooled syngas stream is at a temperature ranging from about 500° C. to about 570° C.

12. The system of claim 8, wherein the second process unit is a heat exchanger.

13. The system of claim 8, wherein the second cooled syngas stream is at a temperature ranging from about 250° C. to about 350° C.

14. The system of claim 8, wherein heat absorbed in the second process unit is used to generate steam.

15. The system of claim 11, wherein the heat absorbed in the second process unit is utilized by integrating with another process stream within the syngas generation system.
